(19) United States
(12) Patent Application Publication
(10) Pub. No.: US 2006/0088689 A1
(43) Pub. Date: Apr. 27, 2006

(54) Floor mat for automobile and other places

(76) Inventors: Andre Lemire, Dorval (CA); Paul Bourque, Lachine (CA)

Correspondence Address: ANDRE LEMIRE, 765 AV. DE L'EGLISE, DORVAL, QC, H9S 1R8, CA

(21) Appl. No.: 11/256,820

(22) Filed: Oct. 25, 2005

(30) Foreign Application Priority Data
Oct. 21, 2004 (CA) 2,482,552

(51) Int. Cl. B32B 3/10

(52) U.S. Cl. 428/137

(57) ABSTRACT

The invention consists of a floor mat for automobile and other places that is absorbent and removable and utilized to protect passengers' clothes, car floor or other places against accumulation and overflow of water, melting snow, slush and dirt. The floor mat comprises three superposed sheets: a first one on top built with ridges and holes to allow the flowing of liquids, a middle one made of an absorbent material to collect the flow of liquids, and a bottom one to make it waterproof. The top and bottom sheets are made of flexible and waterproof materials. They are held together at their extremities in such a way as to allow the insertion of the middle and absorbent sheet. This middle sheet, which may be removed, retains water, melting products and prevents an overflow.

### BACKGROUND OF THE INVENTION

1. Field of the Invention

This invention relates to floor mats for automobile and other places which are designed to protect clothes and floors from damages due to water, calcium and mud.

2. Discussion of Related Art

Automobile floor mats are well known and used to protect the carpeting in a vehicle from damage due to wear, moisture and dirt. However, the standard floor mat has a major disadvantage in that the elements from which the carpeting is protected builds up on the floor mat and may cause damage to the passengers' clothes. The overflow of liquids may also damage the floor of the vehicle.

One automobile floor mat includes a central pan with surrounding sides for catching fluid. This device does not totally prevent the accumulation of fluid and the overflow on clothes and floor. Another type of car floor mat includes a central pan with a foam pad to recuperate and retain water and dirt. The capacity to retain liquids is improved but not totally satisfactory. The bottom part may still accumulate water and spoil clothes. The foam pad may be difficult to clean.

In order to completely eliminate the accumulation of liquids on the surface of the floor mat, contamination of clothes and also the overflow, a new type of floor mat has been designed. It is made of three superposed sheets.

The surface sheet has ridges and orifices to collect and direct liquids to the second sheet. The second sheet is absorbent, removable, may be cleaned and replaced. The bottom sheet is waterproof and openings along the border allow drying of the middle sheet. The top and bottom sheets are attached and may be separated. The middle sheet may be replaced by other absorbent materials.

The quality and functions of the floor mat are maintained and liquids are removed from the surface.

### SUMMARY OF THE INVENTION

The main purpose of the invention is to create a floor mat for automobile and others places that will collect liquid residues in such a way as to eliminate the contamination of the passenger's clothes and the floor.

To accomplish this objective, a new floor mat has been created that includes three superposed sheets. On top, a surface sheet to collect liquid residues, melting snow, mud and calcium. A second sheet in the middle to absorb the liquid residues. A third waterproof sheet to prevent the overflow on the floor.

The surface sheet includes ridges and holes to collect liquids and to evacuate them to the second absorbent sheet. The ridges will prevent contact of the clothes with the flowing liquids. A ridge on the edge will retain the liquids on the surface of the sheet and prevent the overflow.

The second sheet underneath the surface sheet is designed to collect flowing liquids from the holes. It is made of an absorbent material and possesses sufficient capacity to retain liquids. Holes on the surface sheet and openings in the edges of the bottom sheet will permit drying. The innovation is the possibility to remove this absorbent sheet in order to clean it. It may also be replaced by another absorbent material.

The third bottom sheet is made of waterproof material to hold and prevent overflow on the floor. Along the edges, openings facilitate drying of the absorbent sheet.

The surface and bottom sheets are attached together at their extremities but may be separated to allow the insertion of the absorbent sheet.

### BRIEF DESCRIPTION OF THE DRAWINGS

The above and other objects of the invention will become more readily apparent as the invention becomes more clearly understood in connection with the detailed description set forth below, and the accompanying drawings in which like reference numerals represent like parts throughout and in which:

FIG. 1 is a plan view of the surface of the floor mat;

FIG. 2 is a plan view of the absorbent middle sheet;

FIG. 3 is a plan view of the bottom sheet;

FIG. 4 is a cross section view of the floor mat taken along line I-II of FIG. 1;

FIG. 5 is a cross section view taken along line III-IV of FIG. 1;

FIG. 6 is a cross section view taken along line V-VI of FIG. 1;

FIG. 7 is a cross section view taken along line VII-VIII of FIG. 1;

FIG. 8 is a cross section view taken along line XI-XII of FIG. 1;

FIG. 9 is a cross section view taken along line IX-X of FIG. 1.

### DETAIL DESCRIPTION OF THE INVENTION

This invention relates to a removable floor mat for automobile and other places including an absorbent sheet that may be removed and placed between two superposed sheets. The one on the surface includes ridges to collect and drain water into holes to the absorbent sheet placed in between the surface and bottom sheets. The bottom sheet is waterproof and prevents the overflow.

Most existing car mats include ridges on the surface to retain water dripping from snow and mud carried by passengers. Liquid remains on the surface of the floor mat. Protection is limited and the accumulation of liquid residues will dirty the clothes. More over, with the acceleration of the vehicle, overflow may occur on the floor.

Another type of floor mat for automobile includes a fixed foam pad. It absorbs and retains a good quantity of water but not sufficiently to prevent all surface accumulation. Dirt and debris may accumulate and block the absorption. Overflow on clothes and floor may result.

In order to eliminate completely the accumulation of surface water on the floor mat and the contamination on clothes and floor that may follow. A new type of floor mat for automobile and other places was conceived including three superposed sheets. A first top sheet made of waterproof and flexible material including ridges and holes to collect and drain liquids to a second sheet underneath. This second sheet has a good absorption capacity and may be removed to be cleaned or replaced. The result is a surface sheet without any accumulation of water. The third bottom sheet made of flexible and waterproof material prevents the overflow on the floor.

The drying of the absorbent sheet is facilitated by the holes of the surface sheet and openings along the edges of the bottom sheet.

The surface and bottom sheets are attached at their extremities, but may be separated to permit the insertion of the absorbent sheet in the middle.

This new type of floor mat possesses a great absorption capacity. It eliminates the accumulation of liquids on the surface of the mat, the contamination of the passenger's clothes and the overflow on the floor of the vehicle or of other places. Since the absorbent sheet may be removed it may also be cleaned and replaced. This innovation assures the performance of the sheet. The absorbent sheet may also be replaced by other similar products.

With reference to the drawings:

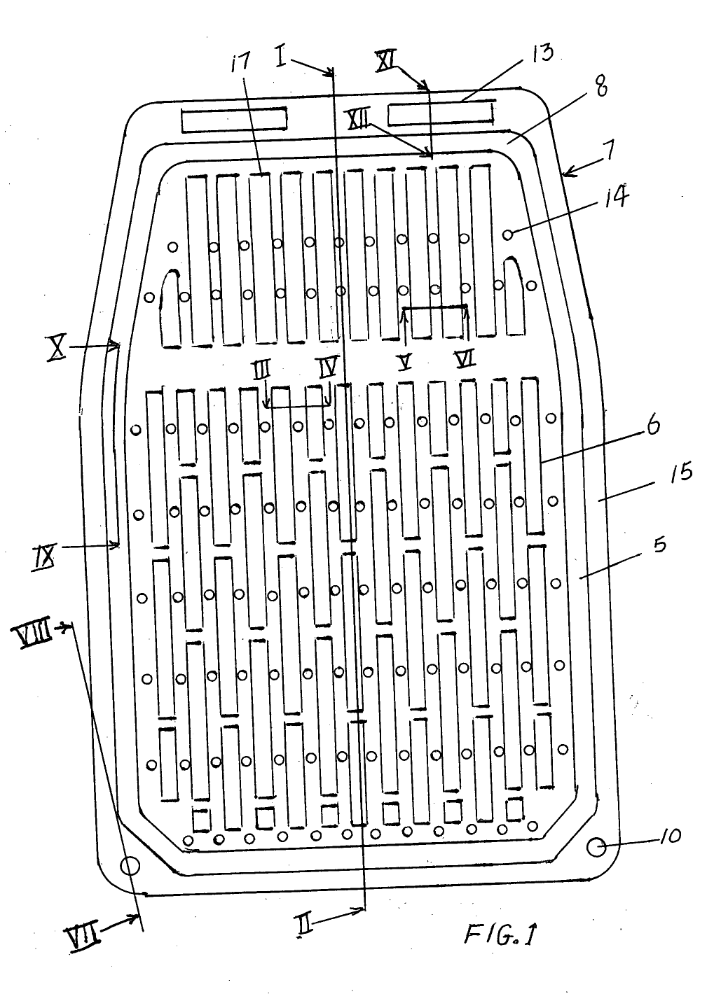

FIG. 1 represents a plan view of the surface of the floor mat;

FIG. 2 represents a plan view of the middle absorbent sheet;

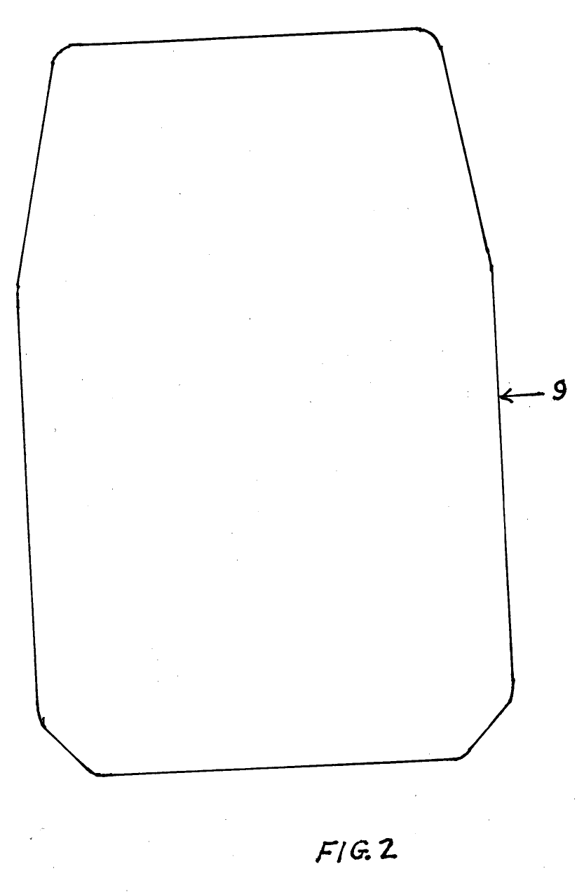

FIG. 3 represents a plan view of the bottom sheet;

FIG. 4 represents a longitudinal view of the floor mat taken along line I-II of FIG. 1;

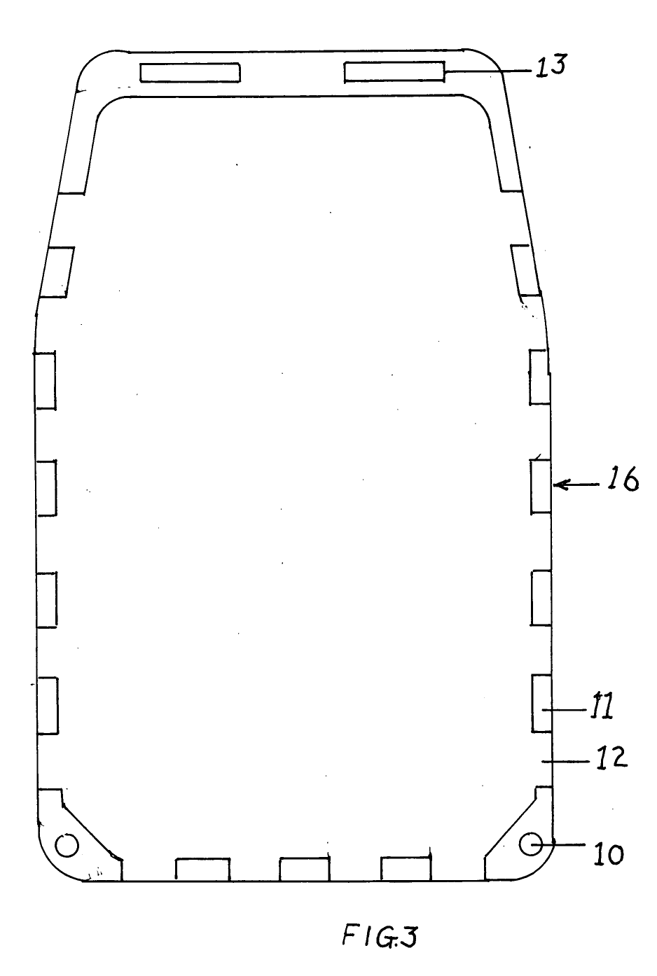

FIG. 5 represents a cross section view taken along line III-IV of FIG. 1;

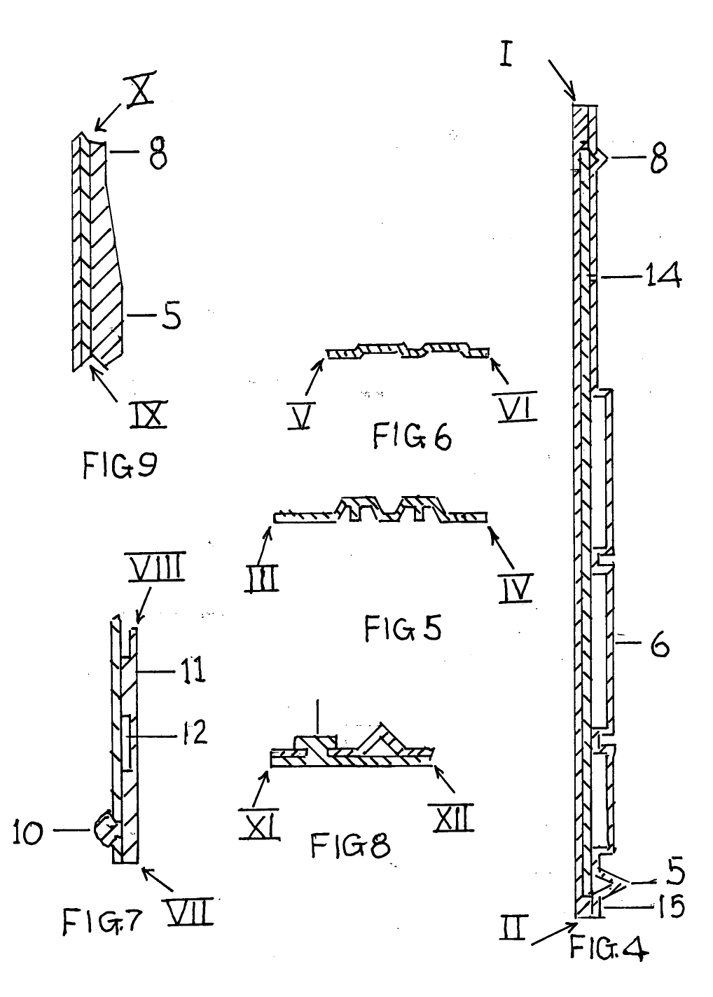

FIG. 6 represents a cross section view taken along line V-VI of FIG. 1;

FIG. 7 represents a cross section view taken along line VII-VIII of FIG. 1;

FIG. 8 represents a cross section view taken along line XI-XII of FIG. 1;

FIG. 9 represents a cross section view taken along line IX-X of FIG. 1.

The floor mat includes, as illustrated, three superposed sheets where the first one on top and the third on the bottom are attached at their extremities in such a way as to permit their separation and the insertion between the two of an absorbent sheet that can be removed.

FIG. 1 shows a plan view of the surface of the floor mat. The sheet on top is made of flexible and waterproof material. The top surface shows a flat edge 15 followed by ridges 5 and 8 to stop the overflow of liquids and debris to the floor. Between these ridges we see the flat part of the surface sheet 7 that includes ridges 6 and holes 14. The ridges 6 canalize liquids to the holes 14 and protect clothes from running water. The holes 14 also act to dry the absorbent sheet.

The top and bottom sheets are attached allowing their separation and the insertion of the absorbent middle sheet.

The line I-II shows a longitudinal view of the floor mat and is shown at FIG. 4.

The line III-IV shows a transverse sectional view of the ridges from the lower part of the floor mat and is shown at FIG. 5.

The line V-VI shows a cross section view of the elevated parts from the upper part of the floor mat and is shown at FIG. 6.

The line VII-VIII shows a cross section view of the device used to attach one extremity of the floor mat and is shown at FIG. 7.

The line IX-X shows a cross section view of the ridge in the transition between the lower part 5 and the upper part 8 of the floor mat and is shown at FIG. 9.

The line XI-XII shows a cross section view of the device used to attach one extremity of the floor mat and is shown at FIG. 8.

The line XI-XII shows a cross section view of the device used to attach one extremity of the floor mat and is shown at FIG. 8.

FIG. 2 shows the absorbent sheet 9 placed in the middle of the floor mat between the surface sheet of FIG. 1 and the bottom sheet of FIG. 3. This sheet will drain liquids through holes 14 of the surface sheet. The holes 14 of the surface sheet and openings 12 of bottom sheet will allow drying.

The absorbent sheet may be removed, cleaned and replaced. It may also be replaced with any other absorbent materials.

FIG. 3 shows the bottom sheet of the floor mat 16, that is used to support the surface and the absorbent sheets. This sheet is made of a flexible and waterproof material. The device 13 attaching the upper parts of the surface and bottom sheets is shown in FIG. 8. The two sheets are also attached in the lower part of the floor mat at corners with device 10 and is shown in FIG. 7.

These two sheets are attached allowing their separation and the insertion of the absorbent sheet in the middle. This bottom sheet 16 includes along the edge openings 12 to help drying of the absorbent sheet.

FIG. 4 shows a longitudinal sectional view of the floor mat along line I-II of FIG. 1. The surface sheet 7 is shown with ridges 6 and the ridges along the edges 5 and 8. The absorbent sheet 9 in the middle and the bottom sheet 16 are shown.

FIG. 5 shows a cross section view along line III-IV of the ridges 6 located in the lower part of the surface sheet. The ridges will collect the flow of liquids and drain them to holes 14 and the absorbent sheet underneath. They also serve to prevent contamination of the passenger's clothes.

FIG. 6 shows a cross section view along line V-VI of the elevated parts 17 of the upper part of the surface sheet. The elevated parts will collect the flow of liquids and drain them to holes 14 and the absorbent sheet underneath.

FIG. 7 shows a sectional view along line VII-VIII of a part of the left corner of the surface and bottom sheets. The devices 10 to attach the lower parts of the surface and bottom sheets are shown with the openings 12 along the edge of the bottom sheet which help drying of the absorbent sheet. Elevated parts 11 along the edge of the bottom sheet assure the positioning of the absorbent sheet.

FIG. 8 shows a sectional view along line XI-XII of the devices 13 attaching the surface and bottom sheets in the upper part of the floor mat.

The above description is meant to be illustrative but not limitative of the invention. Clearly, numerous modifications, additions and other changes may be made without departing from the scope of the invention, as set forth in the appended claims.

What is claimed is:

1. A floor mat for automobile and other places that is absorbent, removable and utilized to protect passengers' clothes and overflow comprising three superposed sheets. The first one on top collects flowing water and directs it through holes toward the second sheet which is absorbent, removable and placed over a third sheet. This last sheet is waterproof as to protect the floor;

2. A floor mat, as defined in claim 1, includes ridges on the top sheet;

3. A floor mat, as defined in claim 1, includes holes between the ridges on the top sheet;

4. A floor mat, as defined in claim 1, includes a ridge on the edges on the top sheet;

5. A floor mat, as defined in claim 1, includes devices to attach on the extremities of the top and bottom sheets;

6. An absorbent and removable floor mat for automobile and other places utilized to protect passengers' clothes and overflow including three superposed sheets;
The first one on top collects flowing water and directs it through holes to the second one which is absorbent, removable and placed over the third sheet. This third sheet is waterproof in order to protect the floors of cars or other places;

7. A floor mat, as defined in claim 6, includes a sheet which is absorbent, may be removed and placed between the top and bottom sheets, in order to retain liquids and melting products;

8. A floor mat, as defined in claim 6, includes a flexible and waterproof third sheet on the bottom;

9. A floor mat, as defined in claim 6, includes a ridge on the edge of the bottom sheet;

10. A floor mat, as defined in claim 6, includes openings on the edge of the bottom sheet to permit drying of the absorbent sheet;

11. A floor mat, as defined in claim 6, includes devices to attach the extremities of the top and bottom sheets.
